(19) United States
(12) Patent Application Publication
(10) Pub. No.: US 2015/0266118 A1
(43) Pub. Date: Sep. 24, 2015

(54) Circular Saw Blade

(71) Applicant: Robert Bosch GmbH, Stuttgart (DE)

(72) Inventors: Marco Barbiero, Udine (IT); Manuel Toniutti, San Vito di Fagagna (IT); Massimo Tolazzi, Udine (IT)

(21) Appl. No.: 14/663,931

(22) Filed: Mar. 20, 2015

(30) Foreign Application Priority Data
Mar. 24, 2014 (DE) 10 2014 205 445.1

(51) Int. Cl. B23D 61/02

(52) U.S. Cl. CPC B23D 61/021

(57) ABSTRACT

A circular saw blade, in particular for the machining of non-metallic workpieces, includes a circular saw blade body and a plurality of saw teeth, wherein the saw teeth are attached to the periphery of the circular saw blade body. The saw teeth have at least one first saw tooth and at least one second saw tooth. The first saw tooth has a saw tooth geometry which is different than the second saw tooth. The first saw tooth has at least two cutting edges and the second saw tooth has at least two cutting edges.

This application claims priority under 35 U.S.C. §119 to patent application number DE 10 2014 205 455.1, filed on Mar. 24, 2014 in Germany, the disclosure of which is incorporated herein by reference in its entirety.

### BACKGROUND

A circular saw blade, in particular for the machining of non-metallic workpieces, includes a circular saw blade body and a plurality of saw teeth, wherein the saw teeth are disposed on the periphery of the circular saw blade body.

A circular saw blade for cutting through wood, derived timber products, plastics and non-ferrous metals, on whose periphery are arranged groups of saw teeth, respectively comprising at least two saw teeth in the form of helical teeth, is already known from DE 201 08 238 U1. One end of the rising cutting edge of at least two of the saw teeth, which end is situated radially further out, is provided with a bevel. Each saw tooth group has a raker of symmetrical cross section.

### SUMMARY

The object of the disclosure is to form with simple measures a circular saw blade for a machine tool, in particular for a hand-held power tool, such that the cutting performance of the circular saw blade in a cutting process is improved.

The disclosure is achieved with a circular saw blade, in particular for the machining of non-metallic workpieces, having a circular saw blade body and a plurality of saw teeth, wherein the saw teeth are attached to the periphery of the circular saw blade body. The saw teeth have at least one first saw tooth and at least one second saw tooth. The first saw tooth has a saw tooth geometry which is different than the second saw tooth. According to the disclosure, the first saw tooth has at least two cutting edges and the second saw tooth has at least two cutting edges.

Through the use of a first saw tooth having at least two cutting edges and a second saw tooth having at least two cutting edges, wherein the first saw tooth has a saw tooth geometry which is different than the second saw tooth, the disclosure makes it possible to ensure an improved feed in a material to be machined. In particular, as a result of two different saw tooth geometries, a smooth running in the cutting process is obtained, whereby cutting forces and vibrations generated in the cutting process are reduced.

The circular saw blade according to the disclosure is of multipart construction and comprises a circular saw blade body and a plurality of saw teeth. The parts of the saw blade can be joined together from different materials. The saw teeth can here be welded or soldered to the circular saw body, or connected to one another by some other connecting method which appears sensible to a person skilled in the art, such as, for instance, by a screw joint. Alternatively, the circular saw blade can be of one-piece configuration. The saw teeth are disposed on the periphery of the circular saw blade body, so that the cutting edges of the saw teeth protrude radially on the periphery of the circular saw blade and thus delimit a radial extent of the circular saw blade. The saw teeth are here distanced apart along a circular arc defined about a longitudinal axis, in particular a rotational axis, of the circular saw blade. In particular, the distance apart of two saw teeth can be defined on the basis of an angle of a sector of a circle. The saw teeth can be arranged at a constant distance apart. The distance between the individual saw teeth along the sector of a circle is here configured as a chip space and is configured to receive or temporarily store chips which accrue in the cutting process. The saw teeth can also however have a varying distance apart or be arranged in groups, wherein the distance apart of the saw teeth in the group is constant or varying. The distance apart of the groups can be constant or varying.

The saw teeth are arranged radially on the periphery such that, in the cutting process, at least one cutting edge of the first saw tooth and, at least in part, a cutting edge of the second saw tooth make contact with the workpiece to be cut or have a cutting effect.

By a cutting edge should in this context be understood an edge which has a scraping and/or material-removing effect on the workpiece to be machined. The cutting edge can here be configured with an obtuse or acute lip angle. Similarly, the cutting edge can be arranged such that the chip angle is acute or obtuse. Both the chip angle and the lip angle can be adapted for the respective application or to the workpiece material which is to be machined.

Furthermore, a saw tooth possesses at least one side edge.

The saw tooth can be configured as a plate which is disposed on the periphery of the circular saw blade body and has at least one cutting edge. The cutting tooth can here be configured such that it can be detachably connected to the circular saw blade body by a screw joint.

The description further defines expedient refinements of the circular saw blade according to the disclosure.

Preferably, the first saw tooth has precisely three cutting edges and the second saw tooth has precisely two cutting edges. In particular, in the cutting process, three cut faces are cut on the workpiece by the three cutting edges of the second saw tooth. These three cut faces in the workpiece are here configured such that the at least two cutting edges of the first saw tooth advantageously penetrate into these three cut faces and abrade these. This forms a plurality of faces which are produced from the cutting edges. Furthermore, a uniform material removal by the second saw tooth in combination with the first saw tooth is enabled, whereby an enhanced feed is obtained.

Preferably, the first cutting edges of the first saw tooth adjoin one another via first cutting corners. The first cutting corners can here be, in particular, of rounded, preferably obtuse configuration. Preferably, the second cutting edges of the second saw tooth adjoin one another via second cutting corners. The second cutting corners can here be, in particular, of rounded, preferably obtuse configuration. The first cutting edges of the first saw tooth can have an angle which is greater than/equal to 90° to the adjacent first cutting edges or first side edges of the first saw tooth. The second cutting edges of the second saw tooth can have an angle which is greater than/equal to 90° to the adjacent second cutting edges or second side edges of the second saw tooth. The angle can here be configured in a range from 90° to 160°, in particular from 95° to 150°, preferably from 100° to 140°, particularly preferably from 100° to 130°. Alternatively, the angle can be configured in a range from 100° to 120°, in particular from 100° to 110°. As a result of the obtuse cutting corners, the cutting forces which act on the cutting corners in the cutting process are minimized. The service life of the circular saw blade or of the cutting edges is thereby increased. The rounded cutting corners advantageously reduce in the cutting corners a singularity or force peaks induced by voltage spikes.

The cutting edges can be configured symmetrically, in particular at least with respect to a plane running substantially orthogonally to the longitudinal axis, in particular to the rotational axis, of the circular saw blade. As a result of the three cutting edges of the second saw tooth, material of the workpiece to be machined is removed better, since the three cutting edges reduce the cutting forces in the direction of feed. As a result of cutting edges arranged symmetrically in the saw tooth, forces acting transversely to the circular saw blade, in particular to side faces of the circular saw blade, cancel one another out, whereby vibrations transversely to the direction of feed are minimized.

It can be expedient for the at least one first saw tooth to be arranged in a first saw tooth group and/or the at least one second saw tooth to be arranged in a second saw tooth group. More particularly, in the peripheral direction, in particular in the rotational direction, the first saw tooth group follows upon the second saw tooth group. The first saw tooth group can here have precisely one first saw tooth or 2, 3, 4, 5 to n first saw teeth (n being a whole number). The second saw tooth group can here have precisely one second saw tooth or 2, 3, 4, 5 to m first saw teeth (m being a whole number, wherein m=n is also possible). The respective saw teeth of the respective saw tooth groups can have, counter to the rotational direction, an equal, an increasing or a decreasing distance apart. It is also possible for the at least one first saw tooth group to be arranged alternately to the, in particular adjacent, at least one second saw tooth group. Preferably, at least one second saw tooth group can follow upon at least one first saw tooth group. Likewise, two or more first saw tooth groups can follow upon two or more second tooth groups. In particular, the adjacent respective saw teeth of the respective saw tooth groups can here be arranged alternately, so that adjacent saw tooth groups have a saw tooth arranged, counter to the rotational direction of the circular saw blade, at the start of the respective saw tooth group, which saw teeth are mutually different.

Furthermore, the at least one first saw tooth and the at least one second saw tooth can be arranged in a third saw tooth group. Preferably, the at least one first saw tooth and the at least one second saw tooth in the third saw tooth group are arranged alternately to one another, in particular adjacent to one another. The third saw tooth group can here have precisely one first saw tooth or 2, 3, 4, 5 to n first saw teeth and precisely one second saw tooth or 2, 3, 4, 5 to m second saw teeth (m being a whole number, wherein m=n is also possible). The third saw tooth group can have, for instance, three first saw teeth and two or three second saw teeth. Alternatively, saw tooth groups can have at least two saw teeth, wherein the two saw teeth are formed of a first and a second saw tooth. As a result, the saw teeth or the saw tooth groups can enable good guidance of the circular saw blade. Furthermore, an alternating arrangement of a first to an adjacent second saw tooth produces a homogeneous alternating load, which optimize torque peaks, and thus corresponding excitation frequencies.

In addition, it is proposed that the geometry of the first saw tooth and second saw tooth is configured such that, if the second saw tooth is projected onto the first saw tooth, there exists on the first saw tooth at least one first face which is not overlapped by a second saw tooth.

In particular, the geometry of the first saw tooth and second saw tooth can be made such that, as a result of the projection of the first saw tooth and of the second saw tooth, there exists on the second saw tooth at least one second face which is not overlapped by a first saw tooth. This means that the first saw tooth introduces contours into the workpiece to be machined and the second saw tooth introduces contours into the workpiece which are different than the contours of the first saw tooth. As a result of the cutting corners of the respective saw teeth, which cutting corners are arranged differently in particular axially to the longitudinal axis, preferably the rotational axis, of the circular saw blade, the saw teeth can penetrate more easily into the workpiece, whereby regions of the workpiece are machined specifically with the first saw tooth. As a result, regions in the workpiece to be machined can be machined or cut specifically by the first saw tooth, and other regions, in turn, specifically by the second saw tooth.

By a projection should in this context be understood an overlay of at least two saw teeth. In particular should herein be understood the overlay of a first saw tooth and of a second saw tooth in a rotary motion of the circular saw blade when passing a same position of the first saw tooth and of the second saw tooth. As a result, the first saw tooth can protrude from the second saw tooth, in particular protrude radially to the longitudinal axis, in particular to the rotational axis, such that the first saw tooth forms the at least one first face, which, as the cutting face, advantageously penetrates into regions of the workpiece to be machined.

It is further proposed that the at least one first face of the first saw tooth is respectively delimited by the first cutting edges and/or first side edges of the first saw tooth from the second cutting edges and/or second side edges of the second saw tooth, and the at least one second face of the second saw tooth is respectively delimited by the second cutting edges and/or second side edges of the second saw tooth from the first cutting edges and/or first side edges of the first saw tooth. As a result, the first cutting edges and the first side edges of the first saw tooth are overlaid with the second cutting edges and second side edges, whereby an advantageous division of the functions of the respective saw teeth is achieved. The first saw tooth can here be configured such that, in a region adjacent to the first side edges, it delivers optimal sawing results to the workpiece to be machined. The second saw tooth can here be configured such that, in a region different than the region adjacent to the first side edges, it delivers optimal sawing results to the workpiece to be machined.

Preferably, a first surface area of the at least one first face of the first saw tooth has a relationship to a second surface area of the at least one second face of the second saw tooth which lies within a range from 0% to 20%, in particular from 2.5% to 15%, preferably from 5% to 10%. As a result, a uniform material removal by the first saw tooth and the second saw tooth is enabled, whereby the saw teeth, and thus the circular saw blade, wear down evenly.

It would be conceivable for the second saw tooth to protrude relative to the first saw tooth by up to 0.8 mm, in particular by up to 0.6 mm, preferably by up to 0.4 mm, in the radial direction of the circular saw blade. This means that the second saw tooth, in particular the cutting corner of the second saw tooth, can penetrate into the workpiece.

In one embodiment, the second saw tooth is set back from the first saw tooth by up to 0.4 mm, in particular by up to 0.3 mm, preferably by up to by up to 0.2 mm, in the radial direction of the circular saw blade. This is advantageous, since the cutting point does not engage in the workpiece to be machined, whereby the tip of the second saw tooth is less heavily loaded.

### BRIEF DESCRIPTION OF THE DRAWINGS

Further advantages emerge from the following drawing descriptions. In the drawing, illustrative embodiments of the disclosure are represented. The drawings and the description contain numerous features in combination. The person skilled in the art will expediently also view the features individually and combine them into sensible further combinations. In the drawings:

FIG. 1 shows a side view of a circular saw blade,

FIG. 2 shows a first embodiment of a first saw tooth,

FIG. 3 shows a first embodiment of a second saw tooth,

FIG. 4 shows an embodiment of the first saw tooth and of the second saw tooth in a projection, and

FIG. 5 shows an alternative embodiment of a first saw tooth and of a second saw tooth in a projection.

### DETAILED DESCRIPTION

In the following figures, the same components are provided with the same reference symbols.

The following figures relate respectively to a circular saw blade 1, in particular for attachment to a machine tool, preferably to a hand-held power tool, having a rotatory working motion and an at least partially translatory feed on or in a workpiece to be machined. The circular saw blade 1 is suitable for the machining, in particular for the sawing machining, of workpieces which are formed of wood, a derived timber product, a plastic or a non-ferrous metal. In principle, the circular saw blade is also suitable for the machining of metallic workpieces, such as, for instance, ferrous metals.

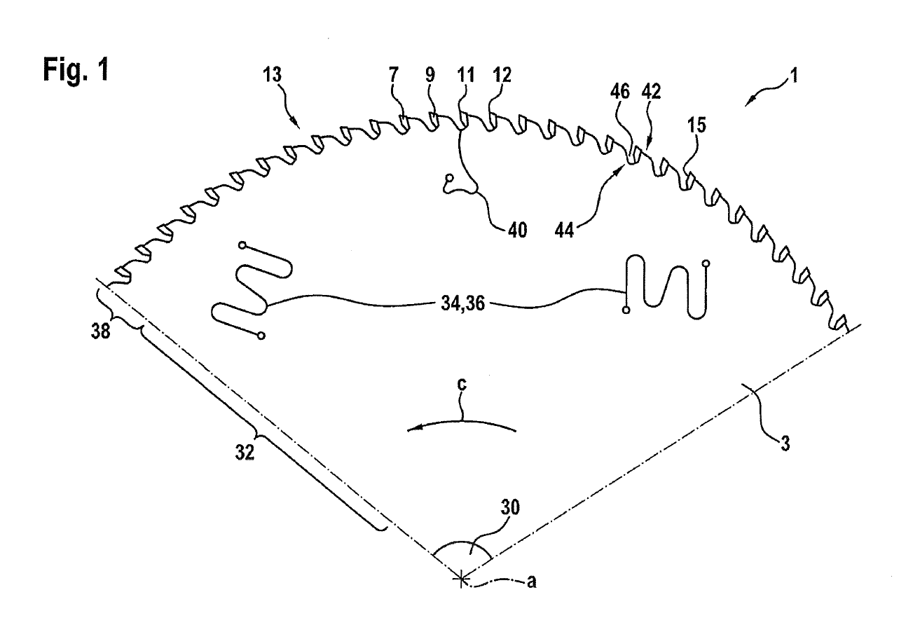

The side view according to FIG. 1 shows a sector of a circular saw blade 1 having a circular saw blade body 3, an opening, a plurality of saw teeth 7, 9 and a plurality of recesses 34, 40. The circular saw blade body 3 has a rotational axis a, which runs through a center point of the circular saw blade 1, in particular of the sector of the circular saw blade. The rotational axis a is here configured as a rotational axis a of the circular saw blade body 3. About the rotational axis a is configured a circular opening 30. The circular opening 30 can be configured to detachably connect the circular saw blade to a shaft, in particular a power-take-off shaft, of a machine tool, in particular a power-take-off shaft of a hand-held power tool.

In a central region 32 of the circular saw blade body 3 are formed recesses 34, in particular linearly curved or serpentine recesses 34. These recesses 34 can have a damping means 36, which is formed of a material different than the circular saw blade body 3. The damping means 36 can be formed of a plastic. The recesses 34 can here be configured as damping elements which damp vibrations of the circular saw blade body 3.

On a peripheral region 38 is formed at least one further recess 40. The recess 40 extends radially in the direction of the longitudinal axis from a peripheral region 38 into a region, in particular the central region 32, adjacent to the peripheral region 38. The recesses 40 are here of linear or serpentine configuration and can be configured as a damping element 36, such as, for instance, the recesses 34 in the central region 32.

The peripheral region 38 runs circularly around the rotational axis a and delimits the circular saw blade body 3 in the radial direction. The circular peripheral region 38 is formed by radially provided depressions 44 and elevations 42, wherein the depressions 44 form an inner circle and the elevations 42 form an outer circle. A depression 44 is followed counter to the rotational direction c by an elevation 42, wherein the elevation 42 passes counter to the rotational direction c back into a depression 44. The respectively one elevation 42 can here respectively have a first saw tooth 7 or a second saw tooth 9. The first saw tooth 7 or the second saw tooth 9 here protrudes, at least in part, radially from the elevation 42. The first saw tooth 7 or the second saw tooth 9 protrudes to both sides, in particular side faces of the circular saw blade body 3. The first saw tooth 7 or the second saw tooth 9 here has at least one first cutting edge 11 or one second cutting edge 12, which radially delimits the circular saw blade 1. The at least one first cutting edge 11 of the first saw tooth 7 or the at least one second cutting edge 12 of the second saw tooth 9 here limits a radial extent of the circular saw blade 1. Between two elevations 42, in particular between two saw teeth 7 and 9, are formed chip spaces 46, which can remove accruing chips from the chip space 46 and store them temporarily during the cutting process.

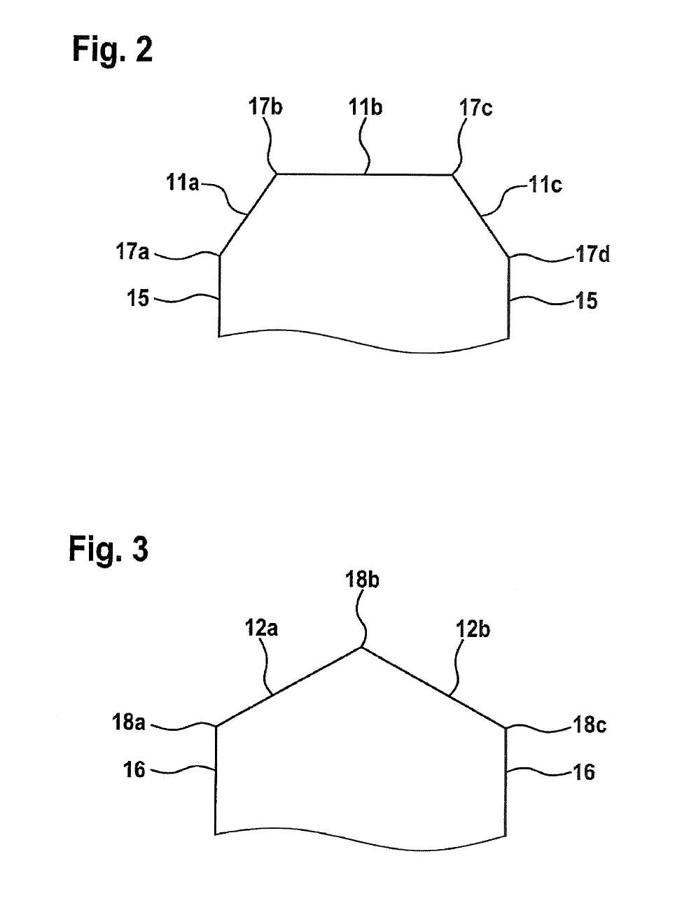

In FIG. 2, a first saw tooth 7 can be seen in detail, as shown already in FIG. 1. The first saw tooth is characterized by three first cutting edges 11a, 11b, 11c and two first side edges 15. The first saw tooth 7 is here delimited laterally, in particular axially to the rotational axis a of the circular saw blade 1, by the two first side edges 15. The two first side edges 15 are respectively adjoined by a first cutting edge 11a, 11c, which here forms corners, in particular first cutting corners 17. These corners, in particular first cutting corners 17, here have an angle which from the first side edge 15 to the first cutting edge 11 is greater than 90° and thus forms an obtuse-angled corner. The two outer cutting edges 11a, 11c of the first saw tooth 7 are here connected by a further first cutting edge 11b of the first saw tooth 7 and form two first cutting corners 17a. The first cutting corners 17 have an angle which is greater than 90°. The first cutting edge 11b here runs transversely, in particular at least substantially orthogonally, to the first side edge 15. Preferably, the first cutting edge 11c runs parallel to a longitudinal axis a of the circular saw blade 1. As a result of the mutually arranged three first cutting edges 11a, 1 lb, 11c, the first saw tooth 7 can be regarded as a trapezoidal saw tooth.

From FIG. 3, a second saw tooth 9, as shown already in FIG. 1, can be seen in detail. The second saw tooth is characterized by two second cutting edges 12a, 12b and two second side edges 16. The second saw tooth 9 is delimited laterally, in particular axially to the rotational axis a of the circular saw blade 1, by the two second side edges 16. The two second side edges 16 are respectively adjoined by a second cutting edge 12a, 12b, which here forms corners, in particular second cutting corners 18a, 18c. These corners, in particular second cutting corners 18a, 18c, here have an angle which respectively from the second side edge 16 to the respectively second cutting edge 12a, 12b is greater than 90° and thus forms an obtuse-angled corner. The two outer cutting edges 12a, 12b of the second saw tooth 9 here converge, in particular in the middle of the second saw tooth 9, into a corner and thus form a second cutting corner 18b. The second cutting corner 18b has an angle which is greater than 90°. As a result of the mutually arranged two second cutting edges 12a, 12b, the second saw tooth 9 can be regarded as a pyramidal saw tooth.

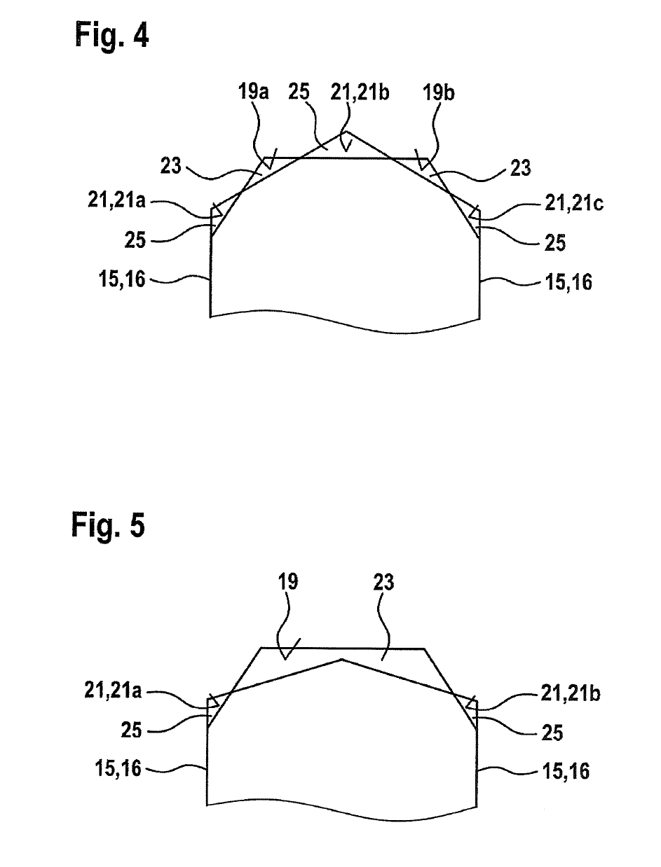

FIG. 4 shows a first saw tooth 7 and a second saw tooth 9 from FIGS. 1 to 3. The first saw tooth 7 and the second saw tooth 9 are here represented in a projection. This projection here constitutes an overlay of the first saw tooth 7 and the second saw tooth 9. The first saw tooth 7 and the second saw tooth 9 are here projected one upon the other in such a way as if the first saw tooth 7 and the second saw tooth 9 were to mutually overlap in a rotary motion of the circular saw blade 1 when passing a same position. The projection here shows that the first cutting edge 11a, 11c of the first saw tooth 7 rises more sharply than the second cutting edge 12a, 12b of the second saw tooth 9, in particular radially counter to the rotational axis a and axially in the direction of a middle of the respective saw tooth 7 or 9.

The first saw tooth 7 and the second saw tooth 9 are here not fully or not 100% mutually overlapped. The second saw tooth 9 overlaps the first saw tooth 7 in particular such that the first saw tooth 7 has two first faces 19a, 19b which are not overlapped by the second saw tooth 9. The non-overlapped two first faces 19a, 19b of the first saw tooth 7 are here delimited by the cutting edges 11 of the first saw tooth 7 and the cutting edges 12 of the second saw tooth 9.

The second saw tooth 9 has three second faces 21a, 21b, 21c which are not overlapped by the first saw tooth 7. The three second faces 21a, 21b, 21c of the second saw tooth 9 are here delimited by the side edges 15 of the second saw tooth 9 and the cutting edges 11a, 11b, 11c of the first saw tooth 7 and the cutting edges 11a, 11b, 11c of the first saw tooth 7. The cutting corner 17 of the second saw tooth 9 here protrudes radially over the cutting edge 11 of the first saw tooth 7.

The at least one first face 19 can here be characterized by a first surface area 23, and the at least one second face 21 by a second surface area 25. The first surface area 23 consists in this embodiment of two first faces 19a, 19b. The second surface area 25 consists in this embodiment of three second faces 21a, 21b, 21c. The first surface area 23 of the first saw tooth 7 has a relationship to the second surface area 25 which lies within a range from a minimum of 0% to a maximum of 20%, in particular from a minimum of 2.5% to a maximum of 15%, preferably from a minimum of 5% to a maximum of 10%. The first surface area 23 is in this embodiment formed of two first faces 19a and 19b. The second surface area 25 is in this embodiment formed by three second faces 21a, 21b, 21c. The first surface area 23 and the second surface area 25 can here be equally large. In particular, the first surface area 23 and the second surface area 25 can differ from each other maximally by up to 20%. The second saw tooth 9, in particular the second cutting edge 12a, 12b, preferably the cutting corner 18b, can here protrude radially relative to the first saw tooth 7, in particular to the first cutting edge 11b, by up to 0.8 mm, in particular by up to 0.6 mm, preferably by up to 0.4 mm.

FIG. 5 has analogously to FIG. 4 likewise a projection of a first saw tooth 7 and of a second saw tooth 9 in a projective representation, in particular from FIGS. 1 to 4. In this embodiment, however, the first saw tooth 7 or the cutting edge 11b of the first saw tooth 7 protrudes radially to the rotational axis a relative to the second saw tooth 9 or to the second cutting edge 12a, 12b, in particular to the cutting corner 18b of the second saw tooth 9. As a result, the first saw tooth 7 has only precisely one first face 19 which is not overlapped by the second saw tooth 9.

The first surface area 23 consists in this embodiment of precisely one first face 19, which is substantially composed of two partial faces. The second surface area 25 consists in this embodiment of precisely two second faces 21a, 21b. The first surface area 23 of the second saw tooth 7 has a relationship to the second surface area 25 which lies within a range from a minimum of 0% to a maximum of 20%, in particular from a minimum of 2.5% to a maximum of 15%, preferably from a minimum of 5% to a maximum of 10%. The first surface area 23 and the second surface area 25 can here be equally large. In particular, the first surface area 23 and the second surface area 25 can differ from each other maximally by up to 20%. The first saw tooth 7, in particular the first cutting edge 11b, can here be radially set back from the second saw tooth 9, in particular the second cutting edge 12a, 12b, preferably the cutting corner 18b, by up to 0.8 mm, in particular by up to 0.6 mm, preferably by up to 0.4 mm.

The disclosure is not limited to the embodiments shown in the illustrative embodiments. Further embodiments according to the description are possible.

What is claimed is:

1. A circular saw blade, comprising:
a circular saw blade body; and
a plurality of saw teeth attached to a periphery of the circular saw blade body, wherein:
the plurality of saw teeth includes at least one first saw tooth and at least one second saw tooth,
the at least one first saw tooth has a saw tooth geometry which is different than the at least one second saw tooth, and
the at least one first saw tooth has at least two first cutting edges and the at least one second saw tooth has at least two second cutting edges.

2. The circular saw blade according to claim 1, wherein the at least one first saw tooth has precisely three first cutting edges and the at least one second saw tooth has precisely two second cutting edges.

3. The circular saw blade according to claim 1, wherein the at least two first cutting edges of the first saw tooth adjoin one another via first cutting corners.

4. The circular saw blade according to claim 1, wherein the at least two second cutting edges of the second saw tooth adjoin one another via second cutting corners.

5. The circular saw blade according to claim 1, wherein the at least two first cutting edges of the at least one first saw tooth have an angle which is greater than or equal to 90° relative to one of a) an adjacent first cutting edge of the at least two first cutting edges and b) a first side edge of the at least one first saw tooth.

6. The circular saw blade according to claim 1, wherein the at least two second cutting edges of the at least one second saw tooth have an angle which is greater than or equal to 90° relative to one of a) an adjacent second cutting edge of the at least two second cutting edges and b) a second side edge of the at least one second saw tooth.

7. The circular saw blade according to claim 1, wherein the at least one first saw tooth is arranged in a first saw tooth group.

8. The circular saw blade according to claim 7, wherein the first saw tooth group includes a number of first saw teeth and the number of first saw teeth is an integer.

9. The circular saw blade according to claim 7, wherein the at least one second saw tooth is arranged in a second saw tooth group.

10. The circular saw blade according to claim 9, wherein the second saw tooth group includes a number of second saw teeth and the number of second saw teeth is an integer.

11. The circular saw blade according to claim 9, wherein, in a rotational direction, the second saw tooth group follows the first saw tooth group.

12. The circular saw blade according to claim 1, wherein the at least one first saw tooth and the at least one second saw tooth are arranged in a third saw tooth group.

13. The circular saw blade according to claim 12, wherein the at least one first saw tooth and the at least one second saw tooth in the third saw tooth group are arranged alternately to one another.

14. The circular saw blade according to claim 1, wherein, in a projection of the at least one first saw tooth and the at least one second saw tooth, as in at a position passed by the at least one first saw tooth and the at least one second saw tooth in a rotary motion of the circular saw blade, the at least one first saw tooth overlaps the at least one second saw tooth such that at least one first face on the at least one first saw tooth is not overlapped by the at least one second saw tooth.

15. The circular saw blade according to claim 14, wherein, in the projection of the at least one first saw tooth and the at least one second saw tooth, the at least one first saw tooth overlaps the at least one second saw tooth such that at least one second face on the at least one second saw tooth is not overlapped by the at least one first saw tooth.

16. The circular saw blade according to claim 15, wherein:
the at least one first face of the at least one first saw tooth is delimited by the at least two first cutting edges and/or first side edges of the at least one first saw tooth from the at least two second cutting edges and/or second side edges of the at least one second saw tooth, and
the at least one second face of the at least one second saw tooth is delimited by the at least two second cutting edges and/or second side edges of the at least one second saw tooth from the at least two first cutting edges and/or first side edges of the first saw tooth.

17. The circular saw blade according to claim 15, wherein:
a first surface area of the at least one first face of the at least one first saw tooth differs from a second surface area of the at least one second face of the at least one second saw tooth by less than or equal to 20%.

18. The circular saw blade according to claim 1, wherein the at least one second saw tooth protrudes relative to the at least one first saw tooth by up to 0.8 mm in a radial direction of the circular saw blade.

19. The circular saw blade according to claim 1, wherein the at least one second saw tooth is set back from the at least one first saw tooth by up to 0.4 mm in a radial direction of the circular saw blade.

20. The circular saw blade according to claim 3, wherein the first cutting corners are rounded.
